(19) United States
(12) Patent Application Publication
(10) Pub. No.: US 2006/0006583 A1
(43) Pub. Date: Jan. 12, 2006

(54) Method for creating a non-porous fair-face surface when casting concrete

(76) Inventor: Janne Samuli Naamanka, Espoo (FI)

Correspondence Address: SHOEMAKER AND MATTARE, LTD, 10 POST OFFICE ROAD - SUITE 110, SILVER SPRING, MD, 20910, US

(21) Appl. No.: 10/536,983

(22) PCT Filed: Dec. 8, 2003
(86) PCT No.: PCT/FI03/00936

§ 371 Date: Jun. 22, 2005

(51) Int. Cl. B28B 7/36; B28B 3/00

(52) U.S. Cl. 264/338; 264/333

(57) ABSTRACT

A casting membrane is used between concrete being cast and its formwork. The casting membrane is formed so that it has at least one plastic coating lying against the concrete being cast, which coating is treated with an electric-discharge treatment.

### BACKGROUND OF THE INVENTION

The present invention relates to a method for creating a non-porous surface when casting concrete.

Concrete being cast copies onto its surface a negative image of the surface structure of the formwork material. In old structures, the pattern of rough-sawn planks used in plank formwork is often visible. Plank formwork has the advantage that the planks absorb water from the surface of the freshly cast concrete and thus blisters are seldom seen on surfaces cast in this way. However, the formwork material must always be treated with so-called formwork stripping agent, which ensures that the formwork will detach from the hardened concrete in one piece, without breaking the new concrete surface. Treatment with stripping agent decisively reduces the planks' water absorption. In present-day concrete technology, the use of plank formwork has diminished considerably. Thus, at present, materials that do not absorb water are used, for example, treated plywood and steel.

The quality of the new concrete surfaces has not come up to expectations, but often leaves much to be desired. Quality requirements have therefore been issued for surfaces, depending on the surface treatment to be given afterwards to the concrete surface, and on the distance from which the concrete surface will be seen. According to the present guidelines issued by the Finnish Concrete Association (Concrete Surfaces, by 40), in the highest quality grade, 20 pores per square meter are permitted on the surface of concrete cast against horizontal formwork. Double this number of pores are allowed in a surface cast against vertical formwork. Keeping the numbers of pores beneath the guidelines generally demands the use of varnished timber formwork. Even then, it is often doubtful whether the surface created will meet the above requirements. It is therefore increasingly uncommon to see surfaces cast against untreated formwork.

Very often, it is imagined that the pores arising in a concrete surface come from the collection, in the interface between the formwork and the concrete, of the air that is naturally trapped in the concrete. However, the pores usually come from the separation of water contained in the concrete mass, as the concrete compacts.

The high surface tension of water causes a large angle of contact between a drop of water and the formwork material, which causes the water to separate into large drops against the concrete and thus form a blister in the hardening concrete. In practice, fresh concrete must be compacted by vibration, and this is the force that collects the water as drops on the formwork surface.

### SUMMARY OF THE INVENTION

The present invention is therefore intended to create a method, with the aid of which a fair-face surface, of very even quality and without blisters, can be achieved in concrete.

This is achieved in the manner described below.

In general, it can be said that the invention is made by using, on the surface of the formwork, a membrane of special material that lies against the concrete being cast, with the aid of which the formation of blisters is prevented.

According to one preferred embodiment, the casting membrane has a three-layer structure, which can comprise a paper-based middle layer and a plastic coating on each side of it. The use of this structure creates a material for the casting membrane that is sufficiently thin and is also sufficiently inelastic and stiff. In the casting membrane, the paper acts precisely as a stiffener and reduces stretch.

However, a membrane, with a plastic coating only on the side of the membrane that comes against the concrete being cast, is also practicable.

However, coating the casting membrane with plastic on both sides will naturally act as more effective moisture-proofing than a membrane surfaced on one side, as the water in the damp concrete will not swell the paper mass.

The casting membrane according to the invention is manufactured in a conventional manner by coating at least one side of a cellulose-based paper web with a membrane of a suitable plastic, or of a plastic composition. After this, the membrane is subject to an electrical treatment, which is usually termed corona treatment. Its principle is that, by exploiting electrical discharges, the surface of the plastic coating is broken at the micro-level. Naturally, the corona treatment can be performed on both sides of the membrane, in cases in which both surfaces are coated with plastic, but it is performed at least on the surface that lies against the concrete being cast during casting.

The aforesaid corona treatment has a positive effect on the surface tension of water. This reduction in surface tension creates precisely a fair-face surface on the concrete that is without blisters and is of an even quality. It is assumed that the excellent casting surface arises because the water in the concrete cast against the formwork can flow in the micro-level passages and does not remain as drops between the concrete and the membrane, which would create blisters in the concrete surface.

### BRIEF DESCRIPTION OF THE DRAWINGS

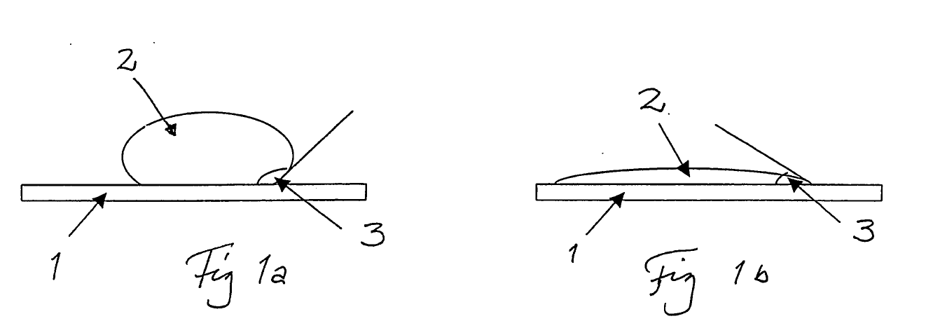

The above behavior of a drop is also illustrated in the accompanying drawings, in which FIGS. 1 a and 1 b show two parallel figures as a series showing the assumed behavior according to the prior art (FIG. 1 a) and the behavior when using a membrane according to the invention (FIG. 1 b).

### DESCRIPTION OF THE PREFERRED EMBODIMENT

In the drawings, the reference number 1 represents the membrane according to the invention while number 2 represents the water drop. The reference number 3, on the other hand, represents the angle of contact between the membrane and the drop, which, in the case of a large drop of water is obtuse, while the angle when using a membrane according to the invention is acute and the drop is widely spread.

The use of the said casting membrane permits the process of casting large units, without creasing or folding. Practical experiments have shown that the method actually works excellently and that with its aid a fair-face surface of excellent quality can be obtained.

A further additional advantage of the invention that can be mentioned is that, when using a casting membrane according to the invention, there is usually no need to use a separate stripping agent, as the formwork material will detach from the hardened concrete easily and completely. In the material according to the invention, there is a stiff non-creasing cellulose-based layer of material, usually of paper, surfaced with a plastic membrane. In a normal situation, the low surface energy of the plastic membrane would, as such, cause the formation of a water drop as described above and through it the formation of a blister in the concrete surface being created. However, as stated above, the surface energy of the plastic membrane can economically and effectively be increased using the said electric discharge treatment, I. e. corona treatment. In corona treatment, the plastic surface is treated using an electric current, which causes sparking and forms ozone. Together, these factors increase the energy of the plastic surface and thus reduce the angle of contact between the formwork surface and the water drop to such an extent that a water drop, and through it a pore, cannot form.

1. A method for creating a non-porous, fair-face surface, when casting concrete, said method comprising a step of placing a casting membrane between the concrete being cast and the formwork, wherein the casting membrane is formed of a plastic coating, which is treated using an electrical discharge treatment, at least on the surface against the concrete being cast.

2. A method according to claim 1, wherein the electrical discharge treatment is a corona treatment.

3. A method according to claim 1, wherein said casting membrane is used on the surface of the formwork, and the membrane comprises a cellulose-based layer, on both sides of which is a plastic coating, at least on the surface lying against the concrete, at least the plastic coating on the surface lying against the concrete being corona treated.
